(19) United States
(12) Patent Application Publication
(10) Pub. No.: US 2016/0112988 A1
(43) Pub. Date: Apr. 21, 2016

(54) METHOD FOR INDICATING ALARM BY PORTABLE TERMINAL AND ACCESSORY IN CONJUNCTION WITH EACH OTHER, AND APPARATUS AND APPLICATION FOR THE SAME

(71) Applicant: Sang Kyu LEE, Seoul (KR)

(72) Inventor: Sang Kyu LEE, Seoul (KR)

(21) Appl. No.: 14/918,333

(22) Filed: Oct. 20, 2015

(30) Foreign Application Priority Data
Oct. 20, 2014 (KR) 10-2014-0141767

(51) Int. Cl. H04W 68/02; H04W 68/00; H04W 4/00

(52) U.S. Cl. CPC H04W 68/02; H04W 4/008; H04W 68/005

(57) ABSTRACT

The present invention relates to a method of indicating, by a portable terminal, an alarm in conjunction with an external accessory, including: registering the accessory such that the accessory is connected only to the portable terminal through short-range wireless communication; configuring an alarm indication condition and method of the accessory and an alarm indication condition.

### BACKGROUND OF THE INVENTION

1. Field of the Invention

The present invention relates to a method for indicating an alarm by a portable terminal and an accessory that operate in conjunction with each other, and an apparatus and an application for the same.

More specifically, the present invention relates to a method in which a portable terminal and an accessory are interconnected through short-range wireless communication to indicate an alarm according to an alarm indication condition that is configured by a user, and an apparatus and an application for the same.

2. Description of the Prior Art

Recently, short-range wireless communication functions have been widely used as smart phones have supported short-range wireless communication functions. Examples of the short-range wireless communication include technical standards, such as Zigbee, Bluetooth, NEC, etc.

Particularly, Bluetooth has been widely used for various purposes as chipsets have recently become more affordable and low-power designs thereof have been achieved. Bluetooth may be mainly used when a low-power wireless connection is required within a short range of about ten meters. For example, if Bluetooth is employed for headsets, the headsets may be designed such that users can listen to music using MP3 players in their pockets without using cumbersome cables.

Meanwhile, portable terminals in the related art indicate alarms by using sounds, vibration, flickering of LCD screens, etc. in cases where incoming calls are received, or in cases where wake-up calls or alarm clocks have been configured. However, users may not carry their portable terminals according to circumstances and thereby may not recognize the alarms. For example, in cases Where the users have placed their portable terminals in their bags or in other rooms, the users may not receive incoming call alarms and thus, may get into trouble.

### SUMMARY OF THE INVENTION

The present invention has been conceived to solve such problems in the art. Particularly, an aspect of the present invention is to provide a method and apparatus in which an accessory connected to a portable terminal through short-range wireless communication can indicate an incoming call alarm.

In addition, another aspect of the present invention is to provide a method and apparatus in which a portable terminal and an accessory can indicate an alarm regarding escaping from a boundary in cases where the distance between the portable terminal and the accessory connected thereto through short-range wireless communication is beyond a preset range.

For this purpose, a method of indicating, by a portable terminal, an alarm in conjunction with an external accessory, according to an embodiment of the present invention, includes: registering the accessory such that the accessory is connected only to the portable terminal through short-range wireless communication; configuring an alarm indication condition and method of the accessory and an alarm indication condition and method of the portable terminal by receiving a user input; transmitting, to the accessory, information on the alarm indication condition and method of the accessory; transmitting an alarm indication request signal to the accessory when receiving an incoming call signal in cases where an incoming call is configured as the alarm indication condition of the accessory; indicating an alarm regarding an escape from a boundary when the accessory is separated a preset distance or more away from the Portable terminal in cases where the alarm Indication condition of the portable terminal is configured as the distance between the accessory and the portable terminal; and indicating an alarm regarding the re-entrance to the boundary when the accessory is within the preset distance from the portable terminal after being separated the preset distance or more away from the portable terminal in cases where the alarm indication condition of the portable terminal is configured as the distance between the accessory and the portable terminal.

A method of indicating, by an accessory, an alarm in conjunction with a portable terminal, according to an embodiment of the present invention, includes registering the accessory such that the accessory is connected to only one portable terminal through short-range wireless communication; receiving information on an alarm indication condition and method from the portable terminal; indicating an alarm when receiving an alarm indication request signal from the portable terminal; indicating an alarm regarding an escape from a boundary when the portable terminal is separated a preset distance or more away from the accessory in cases where the alarm indication condition is the distance from the portable terminal; and indicating an alarm regarding the re-entrance to the boundary when the portable terminal is within the preset distance from the accessory after being separated the preset distance or more away from the accessory in cases where the alarm indication condition is the distance from the portable terminal.

A method in which an external accessory and a portable terminal indicate an alarm in conjunction with each other, according to an embodiment of the present invention, includes: registering the accessory to connect the accessory through short-range wireless communication, by the portable terminal and making a configuration to connect only the portable terminal through the short-range wireless communication, by the accessory; receiving a user input and configuring an alarm indication condition and method of the accessory and an alarm indication condition and method of the portable terminal, by the portable terminal; transmitting information on the alarm indication condition and method of the accessory to the accessory, by the portable terminal; transmitting, by the portable terminal, an alarm indication request signal to the accessory when receiving an incoming call signal in cases where the alarm indication condition of the accessory is an incoming call; indicating an alarm by the accessory when receiving the alarm indication request signal from the portable terminal; indicating, by the portable terminal and the accessory, an alarm regarding an escape from a boundary when the accessory and the portable terminal are separated a preset distance or more from each other in cases where the alarm indication condition of the portable terminal is the distance between the accessory and the portable terminal; and indicating, by the portable terminal and the accessory, an alarm regarding the re-entrance to the boundary when the accessory and the portable terminal become closer to each other within the preset distance after being separated from each other by the preset distance or more in cases where the alarm indication condition of the portable terminal is the distance between the accessory and the portable terminal.

A portable terminal for indicating an alarm in conjunction with an external accessory, according to an embodiment of the present invention, includes: a wireless communication unit that establishes a connection with the accessory through short-range wireless communication; and a controller that controls to: register the accessory such that the accessory is connected only to the portable terminal through short-range wireless communication; configure an alarm indication condition and method of the accessory and an alarm indication condition and method of the portable terminal by receiving a user input; transmit, to the accessory, information on the alarm indication condition and method of the accessory; transmit an alarm. indication request signal to the accessory when receiving an incoming call signal in cases where an incoming call is configured as the alarm indication condition of the accessory; indicate an alarm regarding an escape from a boundary when the accessory is separated a preset distance or more away from the portable terminal in cases where the alarm indication condition of the portable terminal is configured as the distance between the accessory and the portable terminal; and indicate an alarm regarding the re-entrance to the boundary when the accessory is within the preset distance from the portable terminal after being separated the preset distance or more away from the portable terminal.

An accessory for indicating an alarm in conjunction with a portable terminal, according to an embodiment of the present invention, includes: a wireless communication unit connected only to one portable terminal through short-range wireless communication; and a controller that controls to receive information on an alarm indication condition and method from the portable terminal; indicate an alarm when receiving an alarm indication request signal from the portable terminal; indicate an alarm regarding an escape from a boundary when the portable terminal is separated a preset distance or more away from the accessory in cases where the alarm indication condition is the distance from the portable terminal; and indicate an alarm regarding the re-entrance to the boundary when the portable terminal is within the preset distance from the accessory after being separated the preset distance or more away from the accessory.

An application used by a portable terminal to indicate an alarm in conjunction with an external accessory is stored in a medium in order to execute: a step of registering the accessory such that the accessory is connected only to the portable terminal through short-range wireless communication; a step of configuring an alarm indication condition and method of the accessory and an alarm indication condition and method of the portable terminal by receiving a user input; a step of transmitting, to the accessory, information on the alarm indication condition and method of the accessory; a step of transmitting an alarm indication request signal to the accessory when receiving an incoming call signal in cases where an incoming call is configured as the alarm indication condition of the accessory; a step of indicating an alarm regarding an escape from a boundary when the accessory is separated a preset distance or more away from the portable terminal in cases where the alarm indication condition of the portable terminal is configured as the distance between the accessory and the portable terminal; a step of indicating an alarm regarding the re-entrance to the boundary when the accessory is within the preset distance from the portable terminal after being separated the preset distance or more away from the portable terminal in cases where the alarm indication condition of the portable terminal is configured as the distance between the accessory and the portable terminal.

According to the present invention, an alarm indication accessory can be configured to be connected only to one portable terminal through Bluetooth communication, thereby designing the structure of the accessory to be very simple.

Further, according to the present invention, it is possible to indicate an incoming call alarm, a time alarm, is etc. through an alarm indication accessory in various manners, such as visual, auditory, and tactile manners, thereby enhancing user convenience.

In addition, according to the present invention, it is possible to estimate the distance between an accessory and a portable terminal, which are connected through Bluetooth, by using the communication intensity therebetween and to indicate an alarm regarding an escape from a boundary and re-entrance to the boundary by using the estimated distance. Therefore, the present invention can be utilized when a portable terminal, a child, or a pet is lost.

### BRIEF DESCRIPTION OF THE DRAWINGS

The above and other objects, features, and advantages of the present invention will be more apparent from the following detailed description taken in conjunction with the accompanying drawings, in which

FIG. 1 is a block diagram illustrating configurations of a portable terminal and an accessory according to an exemplary embodiment of the present invention;

FIG. 2 is a diagram illustrating an example in which the portable terminal and the accessory are connected to each other through short-range wireless communication and indicate an alarm, according to an embodiment of the present invention;

FIG. 3 is a view illustrating an example of a user interface for configuring alarm conditions of the portable terminal and the accessory in the portable terminal, according to en embodiment of the present invention; and

FIG. 4 is a view illustrating an example of a user interface for configuring alarm methods of the portable terminal and the accessory in the portable terminal, according to an embodiment of the present invention.

### DETAILED DESCRIPTION OF THE EXEMPLARY EMBODIMENTS

It is obvious that the present invention is not limited to the embodiments described below and may include various modifications without departing from the technical idea of the present invention. In describing the embodiments, descriptions of technologies which are already known to those skilled in the art and are not directly related to the present invention may be omitted.

Meanwhile, in the accompanying drawings, the same elements are indicated by the same reference numerals. For the same reason, in the accompanying drawings, some elements may be exaggerated, omitted, or schematically illustrated. Hereinafter, exemplary embodiments of the present invention will be described in detail with reference to the accompanying drawings.

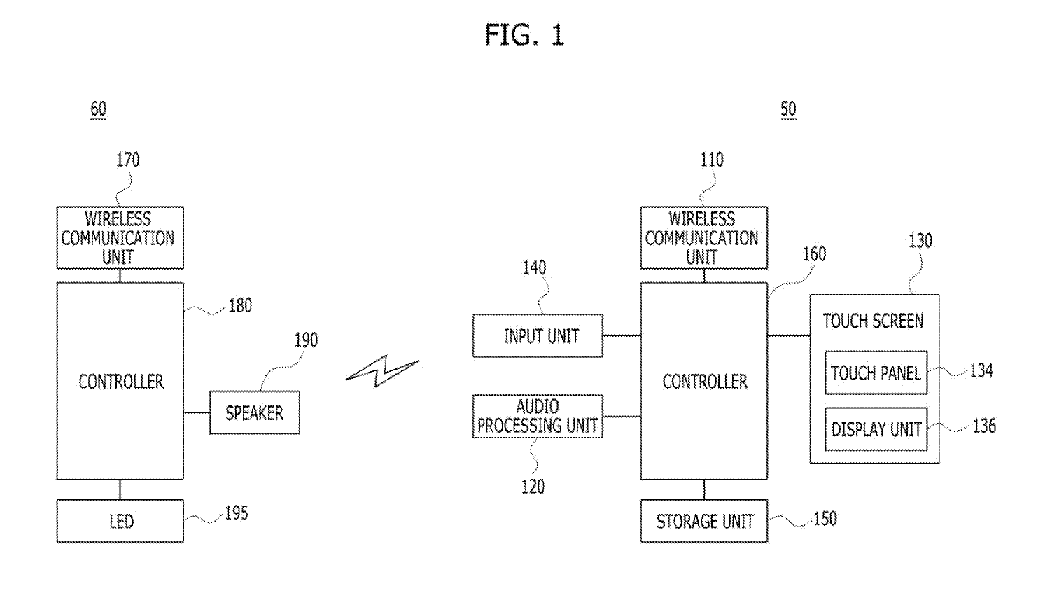

FIG. 1 is a block diagram illustrating configurations of a portable terminal and an accessory according to an exemplary embodiment of the present invention.

As illustrated in FIG. 1, the portable terminal according to the embodiment of the present invention, may include a wireless communication unit 110, an audio processing unit 120, a touch screen 130, an input unit 140, a storage unit 150, and a controller 160.

The wireless communication unit 110 transmits and receives relevant data for wireless communication of the portable terminal 50. The wireless communication unit 110 may include an transmitter that up-converts and amplifies the frequency of a transmitted signal and an RF receiver that low noise-amplifies a received signal and down-converts the frequency thereof. Further, the wireless communication unit 110 may receive data through a wireless channel to output the received data to the controller 160 and may transmit data, which is output from the controller 160, through the wireless channel.

Particularly, the wireless communication unit 110, according to the embodiment of the present invention, may exchange a signal with the accessory 60 external to the portable terminal SO by using a short-range wireless communication standard, such as Bluetooth, Zigbee, NFC, etc.

The audio processing unit 120 may be configured with a codec, and the codec may include data codec that processes packet data, etc. and an audio codec that process an audio signal, such as a voice, etc, Particularly, the audio processing unit 120, according to the embodiment of the present invention, may indicate an alarm with a sound. through a speaker.

The touch screen 130 includes a touch panel 134 and a display unit 136. The touch panel 134 detects a user's touch input. The touch panel 134 may be configured with a touch sensor, such as a capacitive overlay touch sensor, a resistive overlay touch sensor, an infrared beam sensing touch sensor, etc., or may be configured with a pressure sensor. In addition to the aforementioned sensors, any type of sensor that can detect the contact or pressure of an object may be used as the touch panel 134 of the present invention.

The touch panel 134 detects a user's touch input, generates a detection signal, and transmits the detection signal to the controller 160. The detection signal includes data associated with coordinates where the user inputs a touch. In cases where the user moves a touch point, the touch panel 134 generates a detection signal that includes coordinate data on the path along which the touch point moves and transmits the detection signal to the controller 160.

Particularly, the touch panel 134 may receive a user input for setting an alarm indication condition and method according to an embodiment of the present invention. Examples of the alarm indication condition may include incoming call paging, specific time, and the distance between the accessory and the portable terminal. in the case of the accessory, examples of the alarm indication method may include emitting light, generating heat, and outputting a sound. In addition, a user may set an alarm intensity through the touch panel 134 such that the alarm intensity gradually increases or decreases. For example, the user may make a configuration such that the alarm intensity varies depending on the distance between the accessory and the portable terminal.

The display unit 136 may be formed of a Liquid Crystal Display (LCD), an Organic Light Emitting Diodes (OLED), an Active Matrix Organic Light Emitting Diodes (AMOLED), etc., and may visually provide, to a user, menus, input data, function setting information, or various other pieces of information of the portable terminal 50.

Although the portable terminal 50 of the present invention may include the touch screen as described above, it should be noted that the embodiment of the present invention, which will be described below, is not necessarily applied only to the portable terminal 50 that includes the touch screen. In cases where the present invention is applied to a portable terminal that does not include a touch screen, the touch screen 130 illustrated in FIG. 1 may be modified to perform only the function of the display unit 136, and the input unit 140, which will he described below, may perform the function of the touch panel 134 instead.

The input unit 140 receives a user input for controlling the portable terminal 50, generates an input and transfers the input signal to the controller 160. The input unit 140 may be configured with a keypad that includes numeric keys and direction keys, and may be formed as a function key on a surface of the portable terminal 50. In another embodiment of the present invention, all operations of the portable terminal 50 may also he performed only through the touch screen 130. In this case, the touch panel 134 may perform the function of the input unit 140.

The controller 160 controls the overall operations of the portable terminal 50. Particularly, the controller 160 may control a series of processes of indicating an alarm in conjunction with the external accessory 60, and a description thereof will be given below with reference to the accompanying drawings.

Meanwhile, as illustrated in FIG. 1, the accessory 60, according to the embodiment of the present invention, may include a wireless communication unit 170, a speaker 190, an LED 195, and a controller 180.

The wireless communication unit 170 establishes a connection with the portable terminal 50 through short range communication, such as Bluetooth. Particularly, the wireless communication unit 170, according to the embodiment of the present invention, may be connected only to one portable terminal 50 that has succeeded in pairing by inputting the accessory's unique password in the pairing step of first establishing a connection through Bluetooth communication,

The speaker 190 may perform a function of receiving a signal of the controller 160 to acoustically indicate an alarm, and the LED 195 may also perform a function of receiving a signal of the controller 180 to visually indicate an alarm. Meanwhile, although not illustrated in FIG. 1, the accessory 60, according to the embodiment of the present invention, may further include a heat generation unit. The heat generation unit may perform a function of receiving a signal of the controller 180 to indicate an alarm in a tactile manner.

The controller 180 controls the overall operations of the accessory 60. Particularly, the controller 180 may control a series of processes of indicating an alarm in conjunction with the portable terminal 50 according to an embodiment of the present invention, and a description thereof will be given below with reference to the accompanying drawings.

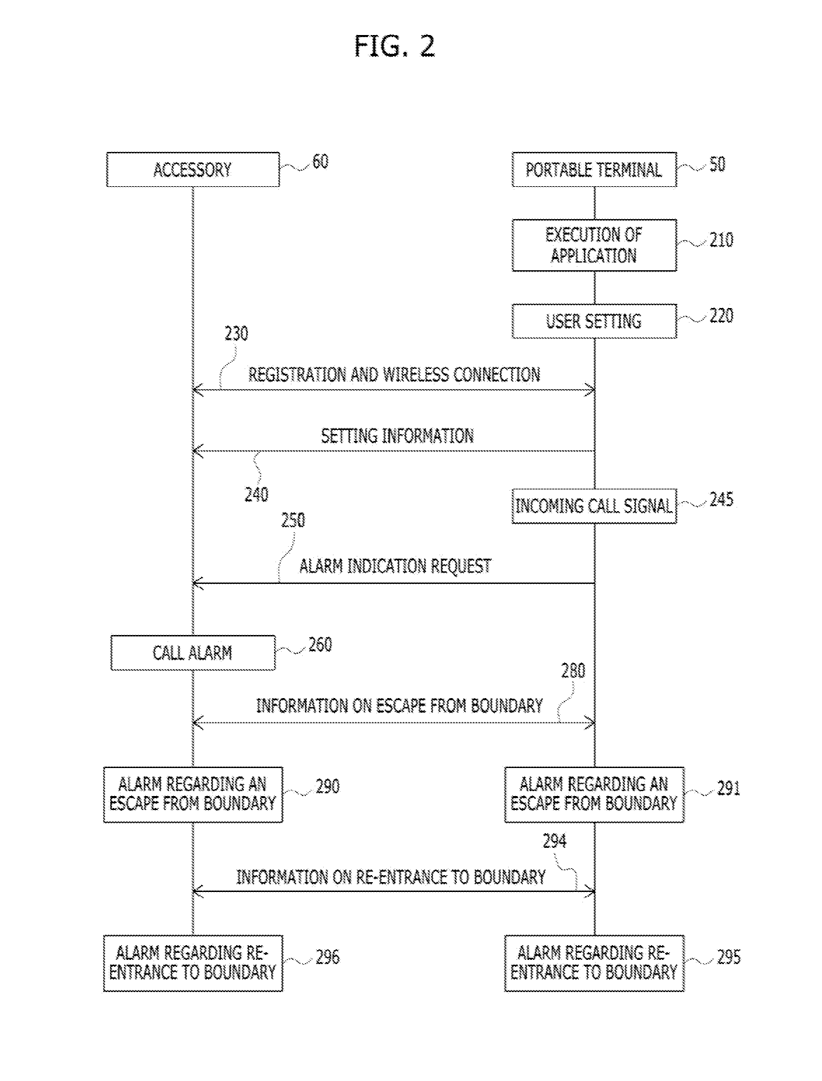

FIG. 2 is a diagram illustrating an example in which the portable terminal and the accessory are connected to each other through short-range wireless communication and indicate an alarm, according to an embodiment of the present invention.

In step 210, the controller 160 of the portable terminal may execute an application that indicates an alarm in conjunction with the external accessory according to the embodiment of the present invention. Although not separately illustrated in FIG. 2, according to an embodiment of the present invention, a step of receiving the application from an external server and installing the application may be further included prior to the step 210.

In step 220, the controller 160 may receive a user input and may set alarm indication conditions and methods of the portable terminal and the accessory.

Examples of the alarm indication conditions may include an incoming call, the distance between the portable terminal and the accessory, an arbitrary date, or an arbitrary data and time. For example, a user may set the alarm conditions such that the accessory or the portable terminal indicates an alarm when an arbitrary date comes.

The alarm indication methods may be set such that an alarm is indicated in a visual, auditory, or tactile manner, and in addition, may be set such that the intensity of the alarm changes. For example, the user may set the alarm indication methods such that the LED of the accessory flickers when the portable terminal and the accessory are away from each other, and may set the alarm indication methods such that the period of flickering becomes shorter as the portable terminal and the accessory are farther away from each other.

In step 230, the wireless communication unit 170 of the accessory 60 and the wireless communication unit 110 of the portable terminal 50 may be connected to each other through short-range communication, for example, Bluetooth. In this case, the controller 160 of the portable terminal 50 may register the accessory by inputting the unique password of the accessory, and the controller 180 of the accessory 60 may make a configuration such that a Bluetooth connection is henceforth made only to the portable terminal that has input the unique password first in the Bluetooth pairing process.

In step 240, the portable terminal 50 may transmit, to the accessory 60, a signal that includes information on the alarm indication condition and method of the accessory 60.

In cases where the portable terminal receives an incoming call signal in step 245, the controller 160 may transmit an alarm indication request signal to the accessory 60 in step 250 if the accessory alarm indication condition corresponds to the incoming call.

The accessory 60 that has received the alarm indication request signal may indicate an alarm regarding the incoming call in step 260. For example, in cases where the alarm setting information received in the step 240 corresponds to visually indicating an alarm under an incoming call condition, the controller 180 of the accessory 60 may visually indicate the alarm by controlling the LED 195 to emit light in step 260. In addition, in cases where the alarm indication request is constantly made in step 250, that is, in cases where the portable terminal continues to receive only the incoming call while a call connection is not made, the accessory 60 may also indicate the alarm by changing the intensity or method by which the alarm is indicated. For example, in step 260, the controller 180 may indicate the alarm by controlling the LED to flicker and may shorten the period in which it flickers.

In step 280, the accessory 60 and the portable terminal 50 may determine whether the accessory 60 and the portable terminal 50 are separated a preset distance or more apart from each other to escape from a boundary. In the embodiment of the present invention, the controllers 180 and 160 may determine whether the portable terminal 50 and the accessory 60 escape from the boundary, by using the intensity of the Bluetooth connection signal between the portable terminal 50 and the accessory 60.

In step 290, the accessory may indicate an alarm regarding the escape from the boundary. For example, in cases where the alarm setting information received in the step 240 corresponds to acoustically indicating an alarm under a boundary escape condition, the controller 180 of the accessory 60 may acoustically indicate the alarm by controlling the speaker 190 to make an output in step 290. In addition, in cases where the Bluetooth connection signal continually weakens, that is, in cases where the accessory and the portable terminal are gradually separated away from each other, the controller 180 of the accessory 60 may also indicate the alarm by changing the intensity or method by which the alarm is indicated. For example, the controller 180 may also indicate the alarm by gradually increasing the audio output in step 290.

Meanwhile, in step 291, the portable terminal may also indicate an alarm regarding the escape from the boundary. For example, in cases where the alarm indication condition of the portable terminal, which has been set in the step 220, corresponds to the escape from the boundary, the portable terminal may indicate the alarm regarding the escape from the boundary according to the preset method.

In step 294, the accessory 60 and the portable terminal 50 may determine whether the distance therebetween has returned to a preset value, in the embodiment of the present invention, the controllers 180 and 160 may determine whether the portable terminal 50 and the accessory 60 have re-entered the boundary, by using the intensity of the Bluetooth connection signal between the portable terminal 50 and the accessory 60.

In step 296, the accessory may indicate an alarm regarding the re-entrance to the boundary. For example, in cases where the alarm setting information received in the step 240 corresponds to acoustically indicating an alarm under a boundary escape condition, the controller 180 of the accessory 60 may control to stop the output of the speaker 190 in step 290. In another example, in cases where the alarm setting information received in the step 240 corresponds to indicating an alarm in a tactile manner under a boundary return condition, the controller 180 of the accessory 60 may indicate the alarm in a tactile manner by controlling to turn the heat generation unit on or off in step 290.

Meanwhile, in step 295, the portable terminal may also indicate an alarm regarding the re-entrance to the boundary. For example, in cases where the alarm indication condition of the portable terminal, which has been set in the step 220, corresponds to the re-entrance to the boundary, the portable terminal may indicate the alarm regarding the re-entrance to the boundary according to the preset method.

The embodiments in the steps 280 to 296 of FIG. 2 may be utilized in various ways.

For example, the user may carry the portable terminal and may make his/her child wear the accessory 60. The user may make both the portable terminal and the accessory indicate an alarm in a visual, auditory, or tactile manner when the child is a predetermined distance or more away from the user, thereby preventing the child from being lost. Such an application example may also be applied to a pet, thereby preventing the pet from being lost.

In another example, in cases where the user lost the portable terminal, the user may more easily retrieve the lost portable terminal by wearing the accessory. In this case, the user may set the accessory to flicker in a shorter period as the accessory closely approaches the portable terminal, thereby preventing the portable terminal from being lost.

Although not separately illustrated in FIG according to another embodiment of the present invention, it is possible to control the function of the portable terminal 50 by using the accessory 60, such as a wireless remote controller, through a Bluetooth connection between the accessory 60 and the portable terminal 50.

In this case, the accessory 60 of FIG. 1 may include an input unit, such as a button, a touch sensor, etc., which can receive a user input. In addition, the user may make a configuration to assign, to the accessory, a remote control function for an arbitrary function of the portable terminal in the step 220 of FIG. 2. In a preferred embodiment of the present invention, the remote control function may be preferably assigned to a photographing function of a camera included in the portable terminal and a play-back or stop function of a media player included in the portable terminal.

For example, in cases where the user assigns, to the accessory, a remote control function for the photographing function of the camera included in the portable terminal, the accessory may transmit a control signal to the portable terminal when receiving a user button input or a touch input for a preset time, and the portable terminal that has received the control signal may operate the camera to take a photo.

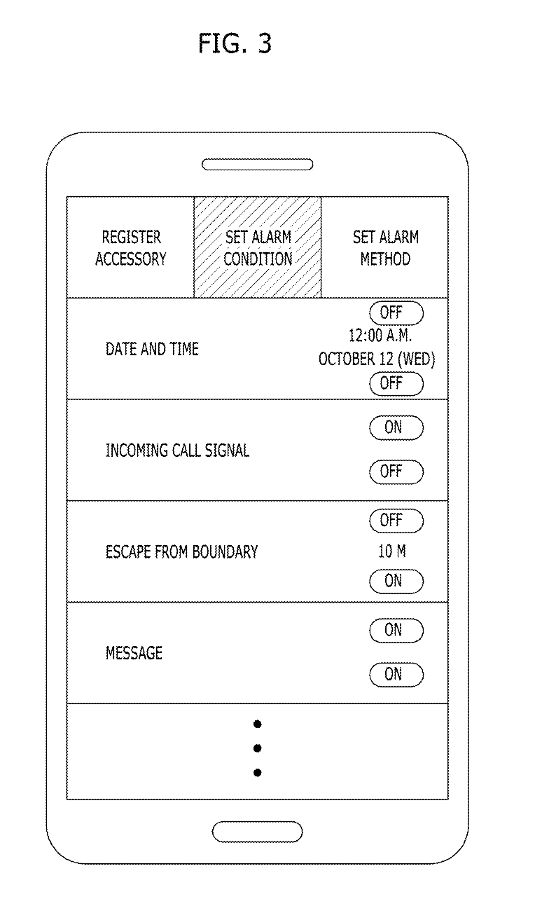

FIG. 3 is a view illustrating an example of a user interface for configuring alarm conditions of the portable terminal and the accessory in the portable terminal, according to an embodiment of the present invention.

When a user executes an application according to an embodiment of the present invention, the user may register the accessory and may individually configure alarm conditions. As illustrated in FIG. 3, the user may configure an arbitrary data, an arbitrary data and time, an incoming call, escape from a boundary, reception of message, etc. as the alarm conditions.

Further, the user may configure alarm on/off of the portable terminal or the accessory for the conditions.

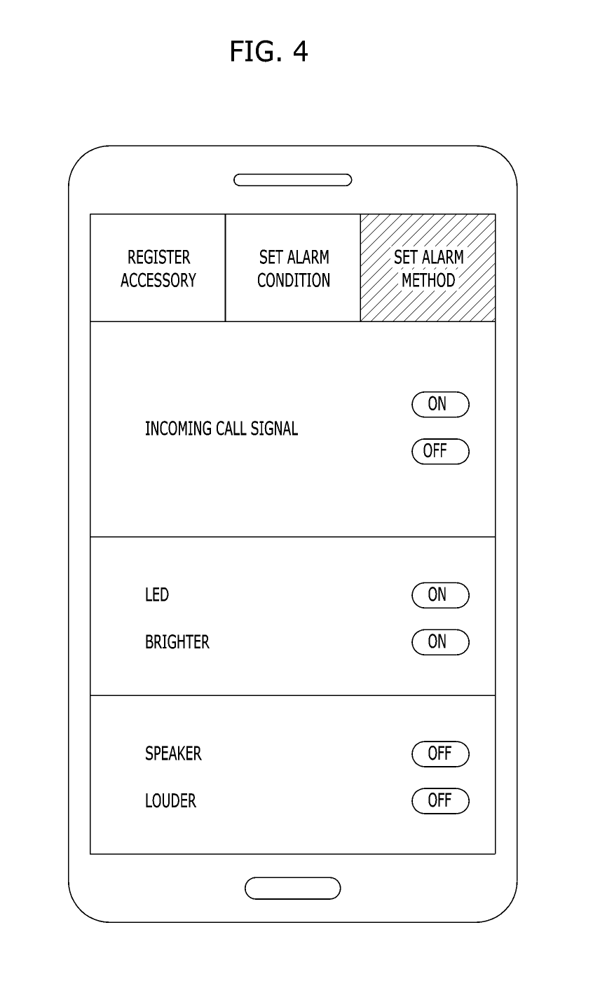

FIG. 4 is a view illustrating an example of a user interface for configuring alarm methods of the portable terminal and the accessory in the portable terminal, according to an embodiment of the present invention.

When a user executes an application according to an embodiment of the present invention, the user may individually configure alarm methods as illustrated in FIG. 4. For example, in cases where an alarm of the accessory is turned on and an alarm of the portable terminal Is turned off under the assumption that an incoming call signal is received, the user may make a configuration such that the LED of the accessory emits light when an incoming call signal is received, and the LED emits more light or the period of flickering is made shorter when the incoming call signal is continually received.

The embodiments of the present invention disclosed herein and shown in the drawings are merely specific examples presented in order to easily describe technical details of the present invention and to help the understanding of the present invention, and are not intended to limit the scope of the present. it will be apparent to those having ordinary knowledge in the technical field, to which the present invention pertains, that it is possible to practice other modified embodiments based on the technical idea of the present invention as well as the embodiments disclosed herein.

### DESCRIPTION OF REFERENCE NUMERALS

50 Portable terminal

60: Accessory

110: Wireless communication unit of Portable terminal

120: Audio processing unit of Portable terminal

130: Touch screen

134: Touch panel of Portable terminal

136: Display unit of Portable terminal

140: Input, unit of Portable terminal

150: Storage unit of Portable terminal

160: Controller of Portable terminal

170: Wireless communication unit of Accessory

180: Controller of Accessory

190: Speaker of Accessory

195: LED of Accessory

What is claimed is:

1. A method of providing, by a portable terminal, an alarm in conjunction with an external accessory, comprising:
establishing a connection with the accessory through short-range wireless communication;
simultaneously configuring alarm conditions or methods of the accessory and the portable terminal by using a menu displayed on a single screen;
transmitting, to the accessory, information on the alarm condition and method of the accessory;
transmitting an alarm request signal to the accessory when receiving an incoming call signal in cases where an incoming call is configured as the alarm condition of the accessory; and
configuring the alarm condition of the portable terminal as the distance between the accessory and the portable terminal and changing an alarm according to the connection signal intensity of the short-range wireless communication to provide the changed alarm in cases where the alarm method is configured to be changed according to the distance,
wherein the configuring of the alarm conditions and methods comprises:
displaying an alarm condition menu that includes one or more alarm condition selection options and icons for selecting alarm on/off of the portable terminal and the accessory for the respective alarm conditions, receiving a user input for the alarm condition menu, and simultaneously configuring the alarm conditions of the portable terminal and the accessory; and
displaying an alarm method menu that includes options for selecting alarm methods for the respective alarm conditions in a visual, auditory, or tactile manner and options for selecting the intensity of the alarm methods, receiving a user input for the alarm method menu, and simultaneously configuring the alarm methods of the portable terminal and the accessory.

2. The method of claim 1, further comprising, after the transmitting of the information on the alarm condition and method of the accessory;
when configuring the alarm condition of the accessory as time, transmitting an alarm request signal to the accessory when the setting time comes.

3. The method of claim 2, wherein the changing of the alarm comprises;
gradually increasing the intensity of the alarm with a decrease in the connection signal intensity of the short-range wireless communication.

4. A method of providing, by an accessory, an alarm in conjunction with a portable terminal, comprising:
establishing a connection with the portable terminal through short-range wireless communication;
receiving information on an alarm condition and method from the portable terminal;
providing an alarm when receiving an alarm request signal from the portable terminal; and
changing the alarm according to the signal intensity of the short-range wireless communication in cases where the alarm condition is the distance from the portable terminal, and the alarm method is configured to be changed according to the distance.

5. The method of claim 4, wherein the changing of the alarm comprises:
gradually increasing the intensity of the alarm with a decrease in the connection signal intensity of the short-range wireless communication.

6. accessory for providing an alarm in conjunction with a portable terminal, comprising:
a wireless communication unit that establishes a connection with the portable terminal through short-range wireless communication; and
a controller that: receives information on an alarm condition and method from the portable terminal; provides an alarm when receiving an alarm request signal from the portable terminal; and changes the alarm according to the signal intensity of the short-range wireless communication in cases where the alarm condition is the distance from the portable terminal, and the alarm method is configured to be changed according to the distance.
